(19) United States
(12) Patent Application Publication
(10) Pub. No.: US 2014/0107257 A1
(43) Pub. Date: Apr. 17, 2014

(54) Inorganic phosphorus-inorganic phosphoric oxyacids compounds and compositions

(71) Applicant: David H. Blount, San Diego, CA (US)

(72) Inventor: David H. Blount, San Diego, CA (US)

(21) Appl. No.: 13/573,880

(22) Filed: Oct. 12, 2012

(51) Int. Cl. C08K 13/02; C08K 3/00

(52) U.S. Cl. CPC C08K 13/02; C08K 3/00
USPC 523/445; 524/404; 524/417; 524/225; 524/83; 524/336; 524/405; 524/186; 524/415; 524/13; 524/27; 524/59; 524/8; 523/451

(57) ABSTRACT

A flame retardant composition is produced by mixing a flammable organic material with an inorganic phosphorus-inorganic phosphoric oxyacid compound or its salts. The inorganic phosphorus-inorganic phosphoric oxyacid compounds are produced by reacting an inorganic phosphorus compound having a valence of 3-4 with an inorganic phosphorus oxyacid with a valence of 5. Carbonization auxiliaries, metal-containing compound having a carbonization acceleration effect, a comb-like polymer and a filler may be added with the flame retardant composition.

This application concerns novel inorganic phosphorus-inorganic phosphoric oxyacid compounds, it's basic salts and compositions. These compounds contain two or more phosphorus atoms in each molecule and contains at least one phosphorus atom containing a valence of 3-4 and one phosphorus atom containing a valence of 5. The flame retardant compounds of this invention may be utilized as flame retardants by incorporating these compounds within or coating a more flammable organic material. In particular, it relates to flame retardant compounds and a flame retardant organic resin compositions, which are free from toxicity problems due to halogen gas generated during combustion or molding as in the use of a halogen-containing flame retardant compound.

### BACKGROUND OF THE INVENTION

Basic nitrogen containing salts of organic polyphosphorus compounds were produced by Blount in U.S. Pat. No. 6,054,515 and utilized in flame retardant compositions. The inorganic phosphorus-inorganic phosphorus oxyacids compounds of this invention are novel. These novel compounds are an improvement over the basic salts of organic polyphosphorus compounds because they do not contain halogens, are a much better flame retardant compounds by rapidly forming a thick intumescent char upon heating with a flame, the inorganic phosphorus acid compounds cost less and it is easier and cost less to produce the inorganic phosphorus-inorganic phosphorics oxyacids. When the inorganic phosphorus-inorganic phosphoric oxyacid compound is incorporated in or on a flammable organic material it produces an intumescent composition. This intumescence also reduces the amount of smoke produced. The flame retardant compounds of this invention will also with stand a higher temperature than the organic phosphorus compounds and basic nitrogen containing salts of organic polyphosphorus compounds before decomposing, and allows them to be mixed in thermoplastic resin to produce flame retardant reins. In the production of organic phosphorus compounds it usually requires the use of carbon halide to react with an organic compound whereas in the production of the inorganic phosphorus-inorganic phosphoric oxyacids no carbon halide is required.

The object of this invention is to produce inorganic phosphorus-inorganic phosphoric oxyacid compounds, its basic salts and compositions containing these compounds which are capable of rendering organic material less flammable. These flame retardant compounds may be used in the production of insulation foam, flexible foams, building components, coating agents, molded plastic products and as hydraulic fluids, lubricants, surfactants, molded plastic products, fertilizer and many other uses.

This inorganic phosphorus-inorganic phosphoric oxyacid flame retardants compounds of this invention are an improvement over the flame retardants produced using organic phosphorus-inorganic phosphorus oxyacid compounds produced by the method of Blount's U.S. Pat. No. 6,545,073 because the flame retardants are much less expensive to produce, easier to produce, are better flame retardants by produce a greater amount of intumescent charring in a shorter length of time thereby preventing the flame to spread. The inorganic phosphorus acids and the inorganic phosphoric oxyacid are readily available and less expensive which is an improvement. Another improvement is that the inorganic phosphorus-inorganic phosphoric oxyacid allows more phosphorus to be utilized in this flame retardant without causing scorching, discoloration and catalyst problems and less of this flame retardant can to be utilized in order to flame retard the organic materials.

### SUMMARY OF THE INVENTION

In one respect, the invention comprises reacting inorganic phosphorus compounds, containing phosphorus atom with a valence of 3-4, with inorganic phosphoric oxyacid compounds with phosphorus atoms with a valence of 5 to produce inorganic phosphorus-inorganic phosphoric oxyacid compounds. Another aspect, the invention comprises utilizing the inorganic phosphorus-inorganic phosphoric oxyacid of this invention by incorporating in, or apply on a more flammable organic material to render the organic material less flammable. Another aspect of the invention is a process to prepare the inorganic phosphorus-inorganic phosphoric oxyacid compound comprising serially contacting and reacting: A) an inorganic phosphorus compound containing a phosphorus atom with a valence of 3-4; B) an inorganic phosphoric oxyacid compound containing a phosphorus atom with a valence of 5; under conditions sufficient to prepare the inorganic phosphorus-inorganic phosphoric oxyacid compound.

Another aspect of this invention is to produce a flame retardant composition which comprising mixing and reacting: A) an inorganic phosphorus compound containing a phosphorus atom having a valence of 3-4; B) an inorganic phosphoric oxyacid compound containing a phosphorus atom with a valence of 5; then electively add, mix and react a basic salt forming compound, then electively add, C) carbonization auxiliaries, D) carbonization accelerating compounds, G) heat reflecting substance, F) filler, under conditions sufficient to prepare the inorganic phosphorus-inorganic phosphoric oxyacid composition. The flame retardant composition may be combined with the flammable organic material in the amount of 5% to 50% based on the weight of the flammable organic material.

In another aspect, according to this invention there is provided a flame retardant basic salt of inorganic phosphorus-inorganic phosphoric oxyacid compound produced by a process comprising of serially mixing and reacting: A) inorganic phosphorus compound containing a phosphorus atom having a valence of 3-4; B) inorganic phosphoric oxyacid compound containing a phosphorus atom having a valence of 5; then electively mix and react; C) basic salt forming compound thereby producing a basic salt of inorganic phosphorus-inorganic phosphoric oxyacid; then electively add and mix, D) carbonization auxiliaries, E) carbonization accelerating compounds F) filler under conditions sufficient to prepare the salt of inorganic phosphorus-inorganic phosphoric oxyacid.

In another aspect, according to this invention, there is provided a flame retardant thermoplastic resin composition which comprises (1) thermoplastic resin, (2) inorganic phosphorus-inorganic phosphoric oxyacid, electively add, (3) basic salt forming compound, (4) carbonization auxiliaries, (5) metal containing compound having a carbonization accelerating effect, (6) comb-like polymer and (7) filler.

The components may be utilized in any suitable amount but preferably; (1) inorganic phosphorus compound, which contains a phosphorus atom containing a valence of 3-4, in the amount of 20 to 100 parts by weight; (2) Inorganic phosphoric oxyacid compound, which contains a phosphorus atom with a valence of 5, in the amount of 20 to 100 parts by weight; (3) An amount of 5% to 30% by weight of the flame retardant compound or it's basic salt or it's composition is added to or applied on the flammable organic material; (4) Basic salt forming compound in the amount of 0 to 100 parts by weight; (5) metal containing compound having a carbonization accelerating effect in the amount of 0 to 40 parts by weight; (6) Comb-like polymer, in the amount of 0 to 100 parts by weight; (7) Heat reflecting compound, such as titanium oxide, in the amount of 0 to 30 parts by weight; (8) Filler, in the amount of 0 to 400 parts by weight; (9) Carbonization auxiliaries, 0-100 parts by weight.

### Component A

Any suitable inorganic phosphorus compound, that contains a phosphorus atom with a valence of 3-4, may be used in this invention, such as, but not limited to, phosphorus acid, phosphorous acid, hypophosphorous, hydrogen phosphite, salts of phosphorus acids and mixtures thereof. Phosphorus acid is the preferred inorganic phosphorus compound. The inorganic phosphorus compound is used in the amount of 20 to 100 parts by weight.

### Component B

Any suitable inorganic phosphoric oxyacid compound which contains a phosphorus atom with a valence of 5 may be used in this invention. Suitable inorganic phosphoric compounds include, but not limited to, phosphoric acid, polyphosphoric acid, pyrophosphoric acid, phosphorus oxide, salts of hydrogen phosphoric acid, phosphonic acid, ammonium hydrogen phosphate, ammonium polyphosphate, triphosphorus acid, phosphinic oxide, phosphorus esters, phosphorus trioxide, phosphorus pentioxide, metaphosphoric acid, hypophosphoric acid, and mixtures thereof. Phosphoric acid is the preferred inorganic phosphoric oxyacid. The phosphoric oxyacid compound is used in the amount of 20 to 100 parts by weight.

### Component C

An suitable salt forming compound that will react with an inorganic phosphorus compound or inorganic phosphoric oxyacid compound may be used in this invention. Suitable salt forming compounds include, but not limited to, compounds containing alkali metals, alkaline earth metals, metals, and nitrogen containing compounds such as compounds containing ammonium radicals, ammonia, amines, amino compounds, polyamines, and aminoplasts, other nitrogen containing compounds and mixtures thereof. Alkylanolamine compounds and amino compounds are the preferred salt forming compound. It is not always necessary to use basic salt forming compounds 0-200 parts by weight may be used, but when used it is utilized in the amount of 5-100 parts by weight.

### Component D

Any suitable carbonization auxiliaries may be utilized in this invention. Suitable carbonization auxiliaries are compounds that in the presence of fire assist the formation of a carbonization foam or char, such as, additives that produce acidic components in the pyrolysis mixture, such as phosphorus acids, boric acids or sulfuric acids. These acidic components are compounds such, for example, acids or salts, or their derivatives of sulfur, boron and phosphorus, such as, boron-phosphates, phosphates, and polyphosphates of ammonia, amines, polyamines, amino compounds, thioureas and alkyanolamines, but boric acid and its salts and their derivatives, organic phosphorus compounds and their salts may also be used for this purpose.

Phosphorus containing compounds, such as, boron-phosphates, phosphates, and polyphosphates of ammonia, amines, polyamines, amino compounds, thioureas and alkyanolamines, boric acid and its salts and their derivatives, organic phosphorus compounds and their salts, halogenated organic phosphorus compounds, their salts and their derivatives may also be used for this purpose. The carbonization auxiliaries and other flame retardant agents may be used in quantities of 0 to 100 parts by weight. In many compositions they are not necessary but when used, it is used in the amount of 5 to 100 parts by weight.

The nitrogen containing salts of phosphorus acids are the preferred carbonization compounds, such as amine phosphates, amine salts of organic phosphorus compounds, amino phosphate, amino salts of organic phosphorus compounds and amino condensation salt of inorganic and organic phosphorus compounds. The amino condensation salt of phosphorus compounds are produced by contacting the amino condensation compounds with phosphorus containing compound that will react with an amino compound, under conditions sufficient to prepare an amino condensate salt of a phosphorus containing compound. Suitable inorganic phosphoric compounds include, but not limited to phosphoric acid, pyrophosphoric acid, triphosphoric acid, metaphosphoric acid, phosphorous acid, hypophosphorous acid, phosphinic acid, phosphinous acid, phosphine oxide, phosphorus trihalides, phosphorus oxyhalides, phosphorus oxide, mono-metal hydrogen phosphates, ammonia dihydrogen phosphate, bromated phosphates, alkaline metal dihydrogen phosphate and halogenated phosphate-phosphite and their halides and acids. Organic phosphorus compounds include, but not limited to, alkyl, cyclic, aryl and alkyl-aryl phosphorus compounds, such as, alkylchlorophosphines, alkyl phosphines, alkyl phosphates, dialkyl hydrogen phosphates, dialkyl alkyl phosphonates, trialkyl phosphates, organic acid phosphates, organic phosphonate esters, aryl phosphates, aryl hydrogen phosphates, halogenated phosphonates esters and mixtures thereof, Amino condensation borates may be produced by contacting boric acid and amino condensation compound under conditions sufficient to prepare the amino condensation borates which may also be utilized and also ammonia borates may be used. Amino condensation boron-phosphates may be produced by contacting boron-phosphates and amino condensation compounds under conditions sufficient to prepare amino condensation boron-phosphate compounds which may also be utilized. The salt forming phosphorus containing compounds will react with the amino condensation compounds to form an amino condensation salt of a phosphorus containing compound which may also be used.

### Component F

Any suitable filler may be used in this invention. The fillers that may be utilized in the flame retardant mixture are usually insoluble in the reaction mixtures. They may be Inorganic substances, such as, alkali metal silicates, alkaline earth metal silicates, metal silicates, silica, metals, metal oxides, carbonates, sulphates, phosphates and borates, Portland cement, grass beads, or hollow beads. Hydrated aluminum oxide is the preferred inorganic compound. They may be organic substances such as amino compounds, such as urea, melamine, dicyandiamide, and other cyanuric derivatives or their formaldehyde resins, aminophosphates, amino salts of organic phosphates, phenol-aldehyde resin powder, powdered coke, graphite, graphite compounds and mixtures thereof in the amount of 0-400 parts by weight.

### Component H

Any suitable organic material which is more flammable than the organic phosphorus-inorganic phosphorus oxyacid compounds or their basic salts of this invention may be used in this invention. Any suitable plastic resin composition or mixtures thereof and any suitable natural organic material may be used in this invention and mixtures thereof in the amount of 100 to 200 parts by weight. These materials may be in the form of a solid, cellular, suspension, emulsion or solution. Suitable plastic resin include, but not limited to, vinyl dienes, vinyl diene copolymers, polyesters, polyester resins, phenoplasts, aminoplasts, polyepoxy resins, polyurethane, furans, polyamides, polyimides, polycarbonates, silicones, polyethers, thioplasts, polytetrafluoroethylene, polysulfones, urethane-epoxy resins, urethane silicate resins or foams, cellulose nitrates, regenerated cellulose, cellulose esters, cellulose ethers, cyanoethyl cellulose and mixtures thereof.

Suitable natural products include, but not limited to, wood, cellulose, lignin-cellulose, paper, cotton, wool, linen, dammars, copols, other natural resins, natural rubber, natural proteins, e.g., soya bean protein, silk, glues gelatin, etc., modified cellulose and mixtures thereof.

Any suitable isocyanate may be used in this invention, organic polyisocyanates are preferred. The commercial available ones are preferred such as tolylene-2,4-diisocyanate, tolylene-2,6-diisocyanate, polymethylene polyphenyl isocyanate, diphenylmethane 4,4′-diisocyanate, 3-methlydiphenyl-methane-4,4′-diisocyanate, m- and p-phenylenediisocyanante, polyphenylpolymethylene isocyanates obtained by phosgenation, commercially known as “crude MDI”, modified polyisacyanates and mixtures thereof. Suitable organic polyisocyanates are exemplified by the organic diisocyanate which are compounds of the general formula wherein R is a divalent organic radical such as an alkylene, aralkylene or arylene radical. Such radical may contain 2 to 20 carbon atoms. Any suitable compound with active hydrogens may be reacted with the polyisocyanates to produce polyurethane products. The preferred compound with active hydrogens are polyols. Polyurethane catalyst, blowing agents, surfactants, foam stabilizers, dyestuff, plasticizers, propellant, desiccant and fillers may also be used. Polyisocyanate which has the formula in which m represent a number from 2 to 4 and Q represents an aliphatic hydrocarbon radical having 2 to 18 C atoms, a cycloaliphatic hydrocarbon radical having 4 to 15 C atoms, an aromatic hydrocarbon radical having 6 to 15 C atoms, or araliphatic hydrocarbon radical having 8 to 15 C atoms and an organic compounds with 1 or more active hydrogens which will react with an isocyanate, containing a urethane catalyst, a plasticizer, propellants and a silicone surfactant may be used as the flammable organic material. Any suitable polyepoxy compounds may be used in this invention such as ally glycidyl ether, tert-butyl glycidyl ether and other polyepoxides.

### Component (1)

Any suitable thermoplastic resin may be used in this invention. Suitable thermoplastic resins include the olefin polymers. The olefin polymers include, for example, homopolymers and copolymers of olefins such as ethylene, propylene, butene-1, pentene-1, hexene-1, heptene-1, octene-1 and the like and, specific samples thereof include polyethylene, polypropylene, ethylene-polypropylene copolymers, ethylene-butene-I copolymer ethylene-hexene-1 copolymers, and ethylene-octene-1 copolymers. Said olefin polymers also include copolymers of said olefin with polar monomers comprising the olefin unit as the main constituent, specifically ethylene-vinyl acetate copolymer, ethylene-methymethacrylate copolymer, ethylene-acrylic acid copolymer, ethylene-vinyl alcohol copolymer and the like. These olefin polymers may be used alone or in combination of two or more. The thermoplastic resin in this invention includes homopolymers and copolymers of unsaturated carboxylic acids and their alkyl esters, such as acrylic acid, methacrylic acid, methylacrylate, methylmethacrylate, and the like, and vinyl esters of saturated carboxylic acids such as vinyl acetate, vinyl butrate and the like. These homopolymers and copolymers may be used alone or in combination of two or more.

Said vinyl aromatic polymers include, for example, homopolymer and coploymers of styrene monomers such as styrene, a-methylstyrene and vinyl styrene, and specific examples thereof polystyrene, poly-a-methylstyrenes, polyvinyltoluene, styrene-a-methylstyrene copolymers and the like. The vinyl aromatic polymers further include, for example, copolymers of styrene with acrylonitrile monomer, maleimide monomer, acrylic acid ester monomer, maleic acid monomer, and specific examples include styrene-acrylonitrile copolymer, styrene-butadiene-acrylonitrile copolymer, styrene-methylacrylate copolymer, styrene-maleic anhydride copolymer and the like. Said vinyl aromatic polymers may also be modified with a rubbery polymer, and the rubbery polymer includes, for example, polybutadiene, styrene-butadiene copolymer, butadiene-acrylonitrile copolymer, ethylene-propylene-diene copolymer, butadiene-acrylic acid ester copolymer and the like. These vinyl aromatic polymers may be used alone or in combination of two or more.

Furthermore, the thermoplastic resin in this invention includes also engineering plastics such as polyphenylene ether, rubber-modified polyphenylene ether, polyethylene terephthalate, polybutylene terephthalate, polyamide, polycarbonate, polyacetal, polysulfone, polyethersulfone, polyphenyene sulfide, polyarylate, polyamide-imide, polyetheramide, polyetherketone, polyetheretherketone, polyimide and the like. The thermoplastic resins in this invention may also be chemically modified products, blends and alloyed products of the above-mentioned thermoplastic resins or may be reinforced with glass fiber or the like.

As the thermoplastic resin to be used in this invention, among the above-mentioned examples, particularly preferable in industry are those consisting of one or more olefin polymers mentioned above or those consisting of one or more vinyl aromatic polymers in view of the moldability and mechanical properties of a flame retardant resin composition prepared by mixing the thermoplastic resin with component, (2), an inorganic phosphorus-inorganic phosphoric oxyacid compound or component, (3), a salt of an inorganic phosphorus-inorganic oxyacid compound, component, (4), a comb-like polymer, (5) a metal-containing compound having a carbonization accelerating effect, component, (6), a carbonization auxiliary and (7) a filler.

When halogen-containing resins, for example, polyvinyl chloride, polyvinyldiene chloride, chlorinated polyethylene, chlorosulfonated polyethylene and the like, are used as polymer of this invention, the flame retardant can be improved, but the halogen-containing resins become a source of generating a toxic gas due to the halogen element contained therein when the resins are burned, and hence, are not the optimum resins to be used in this invention.

### Component (2)

Component (2), a inorganic phosphorus-inorganic phosphoric oxyacid compounds which are produced by reaction component A, an inorganic phosphorus compound containing phosphorus which has a valence of 3 or 4, and component B, an inorganic phosphoric oxyacid compound containing phosphorus which has a valence of 5. The inorganic phosphorus acid and the inorganic phosphoric oxyacid may be in the form of a crystal or in an aqueous solution.

### Component (3)

Component (3), basic salt of inorganic phosphorus-inorganic phosphoric oxyacids compounds are produced by the process of this invention as stated above, by reacting component A, an inorganic phosphorus compound and component B, an inorganic phosphoric oxyacid compound, thereby producing an inorganic phosphorus-inorganic phosphoric oxyacid compound which is then reacted with component C, a salt forming compound. The preferred salt of an inorganic phosphorus-inorganic phosphoric oxyacid compounds to be use to flame retard thermoplastic resins are nitrogen containing salts of inorganic phosphorus-inorganic phosphoric oxyacid compounds. The preferred nitrogen containing compound is urea or a combination of urea and another amino compound and/or ammonia compound. The preferred inorganic phosphorus compound is phosphorus acid and the preferred inorganic phosphoric acid is phosphoric acid. The inorganic phosphorus-phosphoric oxyacid salt is utilized in the amount of 0 to 200 parts by weight.

### Component (4)

A comb like polymer consisting of a polyethyene main chain and a polyoxyalkylene main chain and a polyoxyalkylene side chain can be obtained by, for example, graft-copolymerization of a cyclic ether such as ethylene oxide or propylene oxide to a saponification product of an ethylene-vinyl acetate copolymer, esterification between ethylene-vinyl acid copolymer and polyethylene glycol, poly-propylene glycol or the like, copolymerization of ethylene with w-hydroxypolyethylene oxide macromonomer, or the like. As its production process, the disclosed in Japanese Patent Application is practicable which is a production process comprising heating an ethylene-vinyl acetate copolymer and an alcohol in the presence of an alkali catalyst to saponify them, removing the alcohol and then introducing alkylene oxide there into to form a graft copolymer. The comb like polymers are utilized in the amount of 0 to 30 parts by weight.

### Component (5)

A metal-containing compound having carbonization accelerating effect used in this invention increases the amount of carbonization residue after combustion, thereby enhancing the flame retarding effect. These compounds include, but not limited to, alkaline earth metal borates such as magnesium borate, calcium magnesium borate, manganese borate, zinc borate and the like, metal oxides such as titanium oxide, tin oxide, nickel oxide, zinc oxide and the like, ferrocene, dimethylglyoxime copper, acetyl-acetonatocopper, hydroxyquinoline nickel and the like, zinc thiocarbamate compounds such as zinc dimethylthio-carbamate, zinc di-n-butyldithiocarbamate and the like, mercaptobenzothiazole zinc compounds such as mercaptobenzothiazole zinc and the like, salicylaldehyde zinc compounds such as salicylaldehyde zinc and the like, metal hydroxides such as aluminum hydroxide, magnesium hydroxide, calcium magnesium hydroxide, zirconium hydroxide and the like. The most preferable compounds are selected from zinc oxide, the zinc thiocarbamate compounds, the mercaptobenzothiazole zinc compounds, the salicyaldehyde zinc compounds, zinc borate and the alkaline earth metal borates. Metal containing compounds are utilized in the amount of 0 to 30 parts by weight.

### DETAIL DESCRIPTION OF THE INVENTION

The components are mixed and reacted under conditions sufficient to prepare the inorganic phosphorus-inorganic phosphoric oxyacid compounds and/or composition and flame retarded organic materials. Many of the reactions will take place at ambient temperature and pressure. Some of the reactions are exothermic and may require cooling. Some of the reactions may be speeded up by using an elevated temperature of 100.degree. to 300.degree. C. and pressure. When a gas is used it may be necessary to use increased pressure to compress the gas in order to form a liquid.

It is preferred for the inorganic phosphorus compound to contain a phosphorus atom which has a valence of 3 so that the phosphorus atom will have 2 remaining valences to react with the inorganic phosphoric oxyacid compound which contain a phosphorus atom which has a valence of 5. The inorganic phosphoric oxyacid had active hydrogens to react with the 2 free valences of the inorganic phosphorus compound. The inorganic phosphates has an active oxygen on the phosphorus atom which will react with the inorganic phosphoric oxyacid compounds. The inorganic phosphorus-inorganic phosphoric oxyacid compounds may be produced as a neutral, mildly acidic or moderate acidic compounds.

The salt of inorganic phosphorus-inorganic phosphoric oxyacid compounds are usually produced by mixing and reacting the inorganic phosphorus compound with the inorganic phosphoric oxyacid compound to produce an inorganic phosphorus-inorganic phosphoric oxyacid compound, and then the basic salt forming compound is added and reacted thereby producing a salt of inorganic phosphorus-inorganic phosphoric oxyacid compound. These reactions are usually exothermic but in some reactions it is necessary to heat the mixture up to 300.degree. C. Then the comb-like polymer, carbonization auxiliaries, carbonization accelerators and fillers are added and mixed with the salt of organic phosphorus-inorganic phosphorus oxyacid compound to form a flame retardant composition. The flame retardant salt of inorganic phosphorus-inorganic phosphoric oxyacid compound and/or the flame retardant composition is added on or mixed in the more flammable organic material.

In this invention, the method of mixing the thermoplastic resin, the inorganic phosphorus-inorganic phosphoric oxyacid compound, salt of inorganic phosphorus-inorganic phosphoric oxyacid compound and/or composition, comb-like polymer consisting of a polyethylene main chain and a polyoxyalkylene side chain and a metal-containing compound having a carbonization accelerating effect is not critical. All the above components, thermoplastic resin, inorganic phosphorus-inorganic phosphoric oxyacid compound and/or composition, salt of inorganic phosphorus-inorganic phosphoric oxyacid and/or composition, comb-like polymer, carbonization auxiliaries and metal containing compound may added simultaneously then mixed together by any suitable means. They may be mixed together by using a Banbury mixer, an open roller, a kneader, a single or multiple screw extruder or the like with or without or after mixing by a Henschel mixer, a tumbler mixer or the like. The said mixture is heated until the thermoplastic resin softens or melts, then is thoroughly mixed, then extruded or molded into a desired shape. The inorganic phosphorus-inorganic phosphoric oxyacid compound and basic salt forming compound may be added separate with the thermoplastic resin, and are reacted when the mixture is heated.

The flame retardant thermoplastic composition of this invention may if necessary, have added thereto a heat stabilizer, an antioxidant, a light stabilizer, a lubricant, an antifogging agent, a pigment, a blowing agent, a fluorescent agent, a release agent, a processing aid, a reinforcing agent, and the like which are generally added to a thermoplastic resin, depending upon the uses of the composition.

The inorganic phosphorus-phosphoric oxyacid flame retardant composition is added or applied on the flammable organic material in the amount of 5% to 50% by weight.

### DESCRIPTION OF THE PREFERRED EMBODIMENT

The following examples which describe certain preferred embodiment of the processes may, of course, be varied as described above with similar results. This invention is not limited to the examples below. Parts and percentages are by weight unless otherwise indicated.

The following Reference Examples shows method for producing the inorganic phosphorus-inorganic phosphoric oxyacid compounds and composition, basic salt of inorganic phosphorus-inorganic phosphoric oxyacid compounds and compositions, and the comb-like polymer consisting of a polyethylene main chain and a polyoxyalkylene side chain.

### REFERENCE EXAMPLES

### Example 1

50 parts by weight of phosphorus acid crystals and 50 parts by weight of phosphoric acid containing 25% water are mixed. The reaction is exothermic and is completed within 30 minutes to 1 hour thereby producing a liquid inorganic phosphorus-inorganic phosphoric oxyacid compound. The chemical reaction may be enhanced by keeping the temperature of the mixture just below the boiling point of the reactants.

### Example 2

25 parts by weight of phosphorous acid crystals and 25 parts by weight of phosphoric acid containing 15% water are mixed and reacted. The reaction is exothermic but the reaction is enhanced by heating up to 100 degree C. and is completed within 30 minutes to 1 hour, thereby producing a liquid inorganic phosphorus-inorganic phosphoric oxyacid compound.

### Example 3

100 parts by weight of inorganic phosphorus acid crystals and 50 parts by weight of phosphoric acid containing 15% water are mixed and reacted. The reaction is exothermic and the temperature of the reactants are keep below their boiling point for 30 minutes to 1 hour thereby producing a liquid inorganic phosphorus-inorganic phosphoric acid compound.

### Example 4

Example 1 is modified where 25 parts by weight of phosphoric acid is used instead of 50 parts by weight thereby producing crystalize inorganic phosphorus-inorganic phosphoric oxyacid.

### Example 5

Example 1 is modified wherein 75 parts by weight of 85% phosphoric acid is used instead of 50 parts by weight.

### Example 6

Example 1 is modified wherein 100 parts by weight of 75% phosphoric acid is used in place of 50 parts by weight

### Example 7

Example 2 is modified wherein phosphoric acid crystals is used in place of 50 parts by weight of the phosphoric acid

### Example 8

Example 1 is modified wherein a mixture of inorganic phosphorus acids are used and selected from commercially available phosphorus acid crystals.

### Example 9

Example 1 is modified wherein an inorganic phosphoric oxyacid compound is used in place of phosphoric acid and selected from the list below; a) polyphosphoric acid b) pyrophosphoric acid c) triphosphorus acid d) metaphosphoric acid a) phosphoric acid mixture f) hypophosphorus acid g) phosphinic acid h) phosphinous acid i) phosphine oxide and mixtures of the above.

### Example 10

Example 1 is modified wherein equal mols of the inorganic phosphorus-inorganic phosphoric oxyacid compounds is reacted with equal mols of a basic salt forming compound to produce a basic salt of inorganic phosphorus-phosphorus oxyacid and the basic salt is selected from the list below: a) urea, b) thiourea, c) ammonia, d) methyl urea, e) ammonium carbonate, f) ammonium bicarbonate, g) dicyandiamide, h) guanidine, i) aminoguanidine, j) methyl amine, k) propylene diamine, l) diethylenetriamine, m) aluminum hydroxide, n) magnesium hydroxide, o) boric oxide, p) ammonium borate, q) urea borate, r) biuret, s) isocyanuric acid, t) hydrolyzed biuret, u) urea condensate, v) urea melamine condensate, w) ethanolamine and mixture of the above.

### Example 11

100 parts by weight of inorganic phosphorus acid and 50 parts by weight of phosphoric acid (containing 25% water) are mixed and reacted. The reaction is exothermic and is complete in 1-2 hours thereby producing a liquid inorganic phosphorus-phosphoric oxyacid.

### Example 12

50 parts by weight of phosphorus acid and 100 parts by weight of phosphoric acid containing 25% water by weight are mixed and heated to 100 degree C. for 1-2 hours thereby producing inorganic phosphorus-phosphoric oxyacid then 100 parts by weight of biuret is added, mixed and heated to above the melting point of biuret thereby producing biuret salt of inorganic phosphorus-phosphoric oxyacid.

### Example 13

Example 12 is modified wherein 100 parts by weight of urea is added to the inorganic phosphorus-phosphoric oxyacid then mixed, heated and reacted by heating the mixture to above the melting point of urea for 1-2 hours thereby producing a urea salt of inorganic phosphorus-phosphoric oxyacid.

### Example 14

Example 11 is modified wherein another inorganic phosphoric oxyacid is used in place of phosphoric acid and selected from the list below: a) pyrophosphoric acid, b) triphosphoric acid, c) polyphosphoric acid, d) phosphinic acid, e) phosphorus acid, f) phosphonous acid, g) phosphine oxide, h) phosphorus oxide, i) ammonium phosphate, j) mono-aluminum phosphate, k) mono-magnesium phosphate, l) boron polyphosphoric acid condensation, p) and mixtures thereof

### Example 15

Example 11 is modified wherein equal mols of a salt forming nitrogen containing compound is reacted with equal mols of the inorganic phosphorus-phosphorus oxyacid compound at ambient temperature and selected from the list below: a) urea, b) thiourea, c) methyl urea, d) biuret, e) hydrolyzed biuret, f) isocyanuric acid, g) hydrolyzed isocyanuric acid, h) dicyandimide, i) dimelamine phosphate, j) melamine borate, k) guanidine, l) aminoguanidine, m) ammonium carbonate, n) guanidine carbonate, o) melamine borate, p) ethylene diamine, q) diethylenetriamine, r) ammonia, s) ethyl isocyanate, t) acetoamide, u) urea melamine condensate, v) hydrolyzed urea melamine condensation, and mixtures of the above.

### Example 16

100 parts by weight of unsaturated polyester resin, 0.5 part by weight of organic peroxide and 15 parts by weight the inorganic phosphorus-phosphoric acid compound produced in Example 1 are mixed then poured into a mold to produce a ⅛″.times.6″.times.6″ sample. The sample is cured for one week then cut in ½″ wide strips. These strips are tested by placing the strips in a vertical position then applying a 4″ blue flame from a Bunsen burner under the strip with the flame hitting the strip. The flame is applied for 10 seconds and if not burning it is applied for another 10 seconds. The strip did not catch on fire after the flame was applied for 20 seconds.

### Example 17

Example 16 was modified wherein 300 parts by weight of Portland cement containing 15%-25% water was added to the unsaturated polyester resin thereby producing a flame retardant polyester concrete. The sample was tested as in Example 16 and did not catch on fire.

### Example 18

50 parts by weight of polymeric MDI (Mondur MR by Mobay), 50 parts by weight of sucrose polyol, (Olin No. 475), containing 1% foam regulator (L5420 by Union Carbide), 025 part by weight of a tin polyurethane catalyst (TI2 by Air Products), an amine catalyst (Polycat R 8020 by Air Products) and 4 parts by weight of water, and 10 parts by weight of urea salt of inorganic phosphorus-phosphoric acid compound produced in Example 1 are mixed then poured into a mold. The mixture foams into a rigid flame retarded polyurethane foam of about 2 lbs. per cubic foot. The foam is cured for 1 week then flame tested using a ½″.times.2″.times.6″ sample which is placed vertically on a frame, then a Bunsen burner with a 2″ high blue flame is placed under the foam sample. The flame applied for 20 seconds as in UL 94 VO. The flame went out as soon as the Bunsen burner was removed. The melted plastic did not burn.

### Example 19

15 parts by weight of biuret salt of inorganic phosphorus-phosphoric oxyacid compound of Example 15b, 15 parts by weight of a polyol component with urethane catalyst (Pro-Design B by 3M), and 30 parts by weight of MDI prepolymer (Pro-Design A by 3M) are mixed and poured into a molds thereby forming solid flame retardant polyurethane samples, ⅛″.times.2″.times.6″. These samples were cured for 1 week then flame tested using a 4″ Bunsen burner flame which was placed at the bottom of a vertical sample for 1 minute. The flame went out as soon as the Bunsen burner was removed. There was about a 2% weight loss.

### Example 20

100 parts by weight of ethylene modified polypropylene glycol (MULTRANOL 7056 by Miles), 20 parts by weight of inorganic phosphorus-inorganic phosphoric acid compound of Example 2, 1 part by weight of silicone surfactant (L6202 by Union Carbide), 3 parts by weight of water, 0.5 weight of amine catalyst (polycat 33L by Air Products), 0.025 parts by weight of tin catalyst (Tl 2 by Air Products) and 50 parts by weight of TDI (MONDUR TD80) are mixed then poured into a mold thereby producing a flame retardant flexible polyurethane foam. The fawn was cured for 1 week, then flame tested by using ½″.times.2″″ samples hung vertically. A 4″ Bunsen burner blue flame was placed under the foam for 1 minute. The flames did not spread and the melted drippings did not burn. The flexible foam was also flame tested by the method of Calif TB 133 test and it passed the test because there was only a weight loss of 52 gms.

### Example 21

Example 21 is modified wherein another polyisacyanate is used in place of TDI and selected from the list below: a) polymeric MDI (MONDUR MR by Miles), b) polymeric MDI (PAPI 27 Dow), c) Polymeric MDI (MONDUR MRS), d) MDI

### Example 22

30 parts by weight of the inorganic phosphorus-inorganic phosphoric acid compound of Example 3, 70 parts by weight of a flexible polyepoxy resin (EPON R 828 by Shell) and 8 parts by weight of diamine (Ancamine by Air Products) are mixed then poured into a ⅛″.times.6″.times.6″ mold and cured. After 1 week the sample is cut into ½″ strips then flame tested by using a Bunsen burner with a 4″ blue flame. The strips were hung vertically then the 4″ Bunsen burner flame was placed at the bottom of the strip for 1 minute. After the flame was removed the flame went out. There was about a 2% weight loss.

### Example 23

30 parts by weight of polyethylene pellets and 5 parts by weight of biuret salt of inorganic phosphorus-inorganic phosphoric acid compound produced by the process of Example 15d, are mixed then heated until the polyethylene is capable of being melt-kneaded, usually in the range of 200°-300° C. The mixture is melt-kneaded until the flame retardant is thoroughly mix in the plastic, The plastic is then pressed into mold to obtain a sample of 1/16″ to ⅛″ thick. The sample is cut into ½″ strips and flame tested by the method of UL 94 VO. The samples were placed vertically then a 4″ blue flame from a Bunsen burner was placed at a 20 degree angle under the sample for two periods of 10 seconds. When the flame was removed the flame went out and the drippings did not catch on fire, The samples had good physical properties.

### Example 24

Example 23 was modified wherein another thermoplastic resin was used in place of polyethylene and selected from the list below and flame tested as in Example 22 with the same results: a) polypropylene, b) polyvinyl acetate, c) polystyrene, d) polyamide (nylon), a) ethylene-vinyl acetate copolymer, f) ethylene-propylene copolymer, g) polyester resin, h) ethylene-acrylic copolymer, i) ethylene-vinyl acetate copolymer, j) ethylene-vinyl alcohol copolymer, k) adipic acid-vinyl acetate copolymer, l) polyvinyl toluene, m) styrene-acrylonitrile copolymer, n) styrene-butadiene copolymer, o) polybutadiene, p) styrene-methyl methacrylate copolymer, q) acrylonitrile-butadiene-styrene copolymer, r) polycarbonate, s) polysulfone, t) polyphenyl ether, u) polybutylene terephthalate, v) ethylene-propylene copolymer, w) polymethyl methacrylate, x) polyvinyl chloride, y) styrene-maleic anhydride copolymer, z) and mixtures of the above.

### Example 25

Example 23 is modified wherein melamine salt of inorganic phosphorus-phosphoric oxyacid compound is used in place of biuret salt.

### Example 26

Examples 23, 24 and 25 are modified wherein carbonization auxiliaries are added in the amount of 3 parts by weight, and selected from the list below. a) ammonium polyphosphate, b) melamine polyphosphate, c) melamine borate, d) melamine phosphate, a) dimelamine phosphate, f) urea phosphate, g) urea polyphosphate, h) boron polyphosphate condensation, i) urea-melaminephosphate, j) dicyandiamide phosphate, k) dimethyl hydrogen phosphate, l) hydrolyzed buiret phosphate, m) biuret phosphate, n) guanidine phosphate, o) sulfamic acid, p) ammonium sulfate, q) ethylamine phosphate, r) boric oxide, s) methyl carbamate phosphate, t) cyanoguanidine phosphate, u) phosphorus oxide, v) diethylenetriamine phosphate, w) urea-melamine phosphate, x) hydrolyzed urea phosphate, y) isocyanuric phosphate and mixtures of the above.

### Example 27

Examples 23, 24 and are modified wherein 1 part by weight of a metal-containing compound having a carbonization accelerating effect compound is added with the components and selected from the list below: a) zinc borate b) zinc oxide c) zinc thiocarbamate d) calcium borate a) ferricene f) aluminum hydroxide g) magnesium hydroxide h) salicylaldehyde zinc i) calcium magnesium hydroxide j) titanium oxide k) manganese borate l) tin oxide m) nickel oxide n) mercaptobenzothiazole zinc o) and mixtures of the above.

### Example 28

Examples 23, 24 and 25 are modified wherein 1 part by weight of a comb-like polymer comprising the polyethylene main chain and polyoxyalkylene side chain is added to the components.

### Example 29

10 parts by weight of phosphoric acid crystals and 30 parts by weight of phosphoric acid crystals are added, mixed, heated and reacted thereby producing a inorganic phosphorus-phosphoric oxyacid compound, then mixed heated and reacted with 20 parts by weight of melamine which is then mixture with 300 parts by weight of polyethylene pellets, then heated to the melting point of the polyethylene. The components are melt-kneaded until they are thoroughly mixed, then pressed into a mold producing samples of 1/16″ to ⅛″ thick. The samples are cut into ½″ strip then flame tested. They are hung in a vertical position, then a 4″ blue flame of a Bunsen burner is placed under the samples with the flame hitting the samples. The flame is left on the bottom of the samples for 10 seconds, then another 10 seconds. The samples did not burn after the flame was removed. The melted plastic did not catch on fire.

### Example 30

20 parts by weight of phosphorus acid crystals and 10 parts by weight of 85% phosphoric acid are mixed and reacted at ambient temperature for 30 minutes thereby producing phosphoric-phosphoric oxyacid compound then mixed, heated and reacted with 20 parts by weight of biuret. This compounds and 200 parts by weight of polypropylene pellets are mixed the heated to about 200.degree. to 250.degree. C. The component are melt-kneaded until they are thoroughly mixed, then pressed into a mold producing samples of ⅙″ to ⅛″ thick. The samples are cut into ½″ strips then flame tested while in a vertical position. A 4″ blue flame of a Bunsen burner is placed on the bottom of the sample for two 10 seconds periods. The samples did not catch on fire. The melted drippings did not catch on fire,

### Example 31

Example 30 is modified wherein 5 parts by weight of melamine phosphate is added and mixed with the biuret salt of inorganic phosphorus-phosphoric oxyacid, then cooled and pulverized into a powder, then added to the polypropylene pellets.

### Example 32

Example 30 is modified wherein 3 parts by weight of zinc borate, 5 parts by weight of ammonium polyphosphorate and 3 parts by weight of a comb-like polymer consisting of a polyethylene main chain and a polyoxyalkylene side chain are added to the polyproplene pellets.

### Example 33

Example 30 is modified wherein another thermoplastic resin is used in place of polyproplylene and selected from the list below: a) polyethylene, b) nylon (polyamide), c) polyvinyl acetate, d) ethylene-vinyl acetate copolymer, a) polyester resin, f) polyvinylidene chloride, g) polyurethane resin, h) polyurethane-epoxy resin, l) polystyrene, j) polymethylstyrene, k) styrene-acrylonitrile copolymer, l) polymethacrylate, m) polycarbonate, n) polyestersulfone, o) butadiene acrylonitrile copolymer, p) polyethylene terephthalate, q) butylene terrephthalate resin, r) styrene-maleic anhydride copolymer, s) polyacetal resin, t) ethylene-propylene-vinyl acetate copolymer, u) silicone resin, v) acrylic acid-methacrylic copolymer, w) polybutylene, x) phenol-aldehyde resin, y) polyimide and mixtures of the above

### Example 34

20 parts by weight of inorganic phosphorus-phosphoric oxyacid of Example 1 and 100 parts by weight of styrene monomer containing a free-radical catalyst system are mixed, and reacted thereby producing a flame retardant polystyrene resin. The flame retardant polystyrene resin was molded into ⅙″ to ⅛″ samples then cut into ½″ strips. These strips were placed vertically in a holder, then flame tested with a 4″ blue flame from a Bunsen burner for two 10 seconds periods, and the samples did not catch on fire.

### Example 35

Example 33 is modified wherein another vinyl monomer is used in place of styrene monomer and selected from the list below: a) acrylonitrile, b) acrylic acid, c) methacrylic acid, d)methyl methacrylate, e) methacrylate, and mixtures thereof

I claim:

1. A halogen free intumescesnt flame retardant composition comprising a flammable organic material in the amount of 100-200 parts by weight selected from the group consisting of plastic resins, natural products and mixtures thereof having incorporated inorganic phosphorous flame retardant produced by mixing, heating and/or reacting the compounds at ambient pressure comprising;
A) inorganic phosphorus oxyacid compound wherein the phosphorus atom has a valence of 3-4, in the amount of 20-100 parts by weight;
then electively add, mix and react;
B) basic salt forming compound, in the amount of 0 to 200 parts by weight;
then electively add and mix;
C) metal containing compound having a carbonization accelerating effect, in the amount of 0 to 30 parts by weight;
D) carbonization auxiliaries selected from the group consisting of phosphorus, boron-phosphorus and boron containing compounds that produce acidic components in the pyrolysis mixture 0 to 100 parts by weight;
E) filler, in the amount of 0 to 400 parts by weight;
component A being 5 to 50% by weight, based on the weight of the flammable organic material.

2. Halogen free intumescent flame retardant composition of claim 1, wherein an amino basic salt forming compounds is added and reacted with the inorganic phosphoric oxyacid compound which has a valence of 3-4, in the amount of 0-100 parts by weight thereby producing a salt of inorganic phosphoric oxyacid.

3. The halogen free intumescent flame retardant composition of claim 1 wherein the carbonization auxiliaries are selected from the group consisting of phosphorus containing compounds, boron containing compounds, boron-phosphorus containing compounds that produce acidic components in the pyrolysis mixture, in an amount of 0 to 100 parts by weight.

4. The halogen free intumescent flame retardant composition of claim 1 wherein the metal-containing compound having a carbonization accelerating effect is selected from the group consisting of zinc oxide, zinc thiocarbamate compounds, mercaptobenzothiazole zinc compounds, salicylaldehyde zinc compounds, zinc borate, alkaline earth metal borates and mixtures of the above in the amount of 0 to 30 parts by weight.

5. The halogen free intumescent flame retardant composition of claim 1 wherein the basic salt forming compounds is selected from the group consisting of ammonia, amino compounds, amines, polyamines, polyamides, alkali metal oxides, hydroxides and carbonates, alkaline earth metal oxides, hydroxides and carbonates, metal oxides, hydroxides and carbonates, metals and mixtures thereof and utilized in the amount of 0 to 200 parts by weight.

6. The halogen free intumescent flame retardant composition of claim 1 wherein the filler is selected from the group consisting of amino compounds, amino phosphates, aminoplasts, phenoplasts, ammonia phosphate, ammonia polyphosphate, powdered synthetic resins, sawdust, carbohydrates, bituminous additive, graphite, graphite compound, cyanuric derivatives or their formaldehyde resins, powdered coke, silica, alkali metal silicates, alkaline earth metal silicates, metals, metal silicates, oxides, carbonates, sulphates, phosphates and borates, glass beads, hollow glass beads, hydrated aluminum oxide, Portland cement and mixtures thereof, in the amount of 0 to 400 parts by weight.

7. A halogen free intumescent flame retardant thermoplastic resin composition having incorporated inorganic phosphorous flame retardant produced by mixing heating and/or reacting the compounds at ambient pressure comprising;
1) thermoplastic resin, in the amount of 100 to 200 parts by weight;
2) inorganic phosphorous oxyacid, wherein the phosphorus atom has a valence of 3-4, in the amount of 5 to 50 parts by weight;
electively adding the following components;
3) basic salt forming compound, in the amount of 0 to 100 parts by weight;
4) comb polymer consisting of a polyethylene main chain and a polyoxyalkylene side chain, in the amount of 0 to 30 parts by weight;
5) carbonization auxiliaries selected from the group consisting of phosphorus, phosphorus-boron and boron containing compounds that produce acidic compounds in the pyrolysis mixture, in the amount of 0 to 100 parts by weight;
6) metal-containing compound having a carbonization accelerating effect, in the amount of 0 to 30 parts by weight;
Component A being 5 to 50% by weight, based on the weight of the thermoplastic resin.

8. (canceled)

9. (canceled)

10. (canceled)

11. (canceled)

12. (canceled)

13. The halogen free intumescent flame retardant composition of claim 1 wherein the flammable organic material is a polyurethane resin mixed and/or heated with an inorganic phosphorous with a valence of 3-4 oxacid thereby producing a halogen free intumescent flame retardant polyurethane composition.

14. The halogen free intumescent flame retardant composition of claim 1 wherein the flammable organic material is an unsaturated polyester resin containing a free-radical initiator curing agent and the flame retardant compound is an inorganic phosphorous oxyacid having a valence of 3-4 thereby producing a halogen free intumescent flame retardant polyester resin composition.

15. The halogen free intumescent flame retardant composition of claim 1 wherein the flammable organic material is a polyester resin and the flame retardant is an inorganic phosphorous oxyacid with a valence of 3-4 thereby producing a halogen free intumescent polyester resin composition.

16. The halogen free intumescent flame retardant composition of claim 1 wherein the flammable organic material is an polyepoxy resin containing an epoxy curing agent and the flame retardant is an inorganic phosphorous oxyacid having a valence of 3-4 thereby producing an intumescesnt flame retardant polyepoxy resin composition.

17. The halogen free intumescent flame retardant composition of claim 1 wherein the flammable organic material is a vinyl monomer containing a free-radical initiator curing system and the flame retardant is an inorganic phosphorous oxyacid with a valence of 3-4 thereby producing intumescent flame retardant vinyl composition.

18. The flammable organic material of claim 1 wherein the flammable organic material is a polyamide thereby producing a flame retardant polyamide and the flame retardant is an inorganic phosphorous oxyacid with a valence of 3-4 thereby producing an halogen free intumescent flame retardant polyamide composition.

19. The halogen free intumescent flame retardant composition of claim 1 wherein the flame retardant compound comprising;
A) inorganic phosphorus compound containing phosphorus atom with a valence of 3 or 4, selected from the group comprising of phosphorus acid flakes, phosphorous acid, hypophosphorous acid and mixture thereof in the amount of 20 to 100 parts by weight.

20. The halogen free intumescent flame retardant of claim 19 wherein the inorganic phosphorus oxyacid is phosphorus acid flakes having a valence of 3-4.

21. Halogen free intumescent flame retardant composition comprising of flammable organic material selected from the group comprising of plastic resins, natural products and mixtures thereof having incorporated inorganic phosphorous flame retardant produced by mixing, heating and/or reacting the compounds at ambient pressure comprising;
A) inorganic phosphorus oxyacid compounds wherein the phosphorus atom has a valence of 3-4, in the amount of 20-100 parts by weight;
component A being 5 to 50% by weight, based on the weight of the flammable organic material.

22. Halogen free intumescent flame retardant composition of claim 21 wherein the phosphorous oxyacid compound is phosphorous flakes having a valence of 3-4.

23. Halogen free intumescent flame retardant composition of claim 21 wherein 0-400 parts by weight of filler is incorporated in the intumescent flame retardant composition.

24. Halogen free intumescent flame retardant composition of claim 21 wherein the plastic resin is polyester resin and the inorganic phosphorous flame retardant is phosphorous flakes having a valence of 3-4.

25. Halogen free intumescent flame retardant composition of claim 21 wherein the plastic resin is an acrylic latex and the inorganic phosphorous flame retardant is phosphorous flakes having a valence of 3-4.
